(19) United States
(12) Patent Application Publication
(10) Pub. No.: US 2024/0166796 A1
(43) Pub. Date: May 23, 2024

(54) EPOXY RESIN FOR SEMICONDUCTOR ADHESIVE, PREPARING METHOD THEREOF AND COMPOSITION COMPRISING THE SAME

(71) Applicant: KOREA INSTITUTE OF INDUSTRIAL TECHNOLOGY, Cheonan-si (KR)

(72) Inventors: Hyun Aee CHUN, Suwon-si (KR); Su Jin PARK, Osan-si (KR); Yun Ju KIM, Seoul (KR); Sook Yeon PARK, Gunpo-si (KR)

(21) Appl. No.: 18/490,764

(22) Filed: Oct. 20, 2023

(30) Foreign Application Priority Data
Oct. 31, 2022 (KR) 10-2022-0142830

(51) Int. Cl. C08G 59/14; C08G 59/24; C08G 59/62; C08G 59/68; C08L 33/08; C08L 63/04; C09J 163/04

(52) U.S. Cl. CPC C08G 59/1444; C08G 59/245; C08G 59/621; C08G 59/688; C08L 33/08; C08L 63/04; C09J 163/04; C08L 2203/206; C09J 2203/326

(57) ABSTRACT

The present disclosure relates to a modified epoxy resin having a weight average molecular weight of 5,000 to 25,000 and a polydispersity index of 5.0 to 20.0, and comprising (1) an epoxy-derived unit and (2) a modifier-derived unit, a preparation method thereof, a composition comprising the same, and uses thereof. When the epoxy composition comprising the modified epoxy resin according to the present disclosure is cured, the epoxy composition has a lowered coefficient of thermal expansion (CTE), i.e., improved thermal expansion properties, due to curing-induced phase separation (morphological properties) into an epoxy region and an acrylic region. The modified epoxy of the present disclosure and the epoxy composition comprising the same are suitable as adhesives for semiconductor packaging.

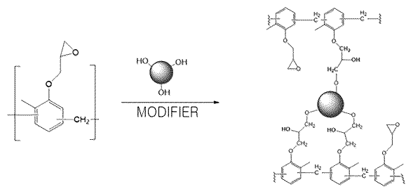

### CROSS-REFERENCE TO RELATED APPLICATION(S)

This application claims benefit of priority to Korean Patent Application No. 10-2022-0142830 filed on Oct. 31, 2022 in the Korean Intellectual Property Office, the present disclosure of which is incorporated herein by reference in its entirety.

### BACKGROUND

### 1. Field

The present disclosure relates to an epoxy resin for semiconductor adhesive, a preparation method thereof, a composition comprising the same (hereinafter referred to as “epoxy composition”), and uses thereof. In more detail, the present disclosure relates to a modified epoxy resin for semiconductor adhesives exhibiting improved thermal expansion properties by controlling the compatibility between an epoxy resin and an acrylic resin by the modified epoxy resin, a preparation method thereof, a composition comprising the same, and uses thereof.

### 2. Description of Related Art

Epoxy materials are widely used in paints, printed wiring boards, IC encapsulants, electrical components, electronic components, adhesives, etc. due to their excellent mechanical properties, electrical insulation, heat resistance, water resistance, and adhesive properties.

However, when applied to semiconductor packaging, epoxy materials have a higher CTE (coefficient of thermal expansion) compared to silicon wafer, so the reliability and processability of parts are significantly limited. Research has been continuously conducted to decrease the coefficient of thermal expansion of epoxy materials. Meanwhile, semiconductor packaging tends to be highly integrated, thin, and large-area packages. In accordance with this trend in semiconductor packaging, warpage and cracking are also becoming more serious in semiconductor packaging due to the high CTE of epoxy materials, which not only makes a semiconductor packaging process impossible, but also makes it difficult to ensure the reliability of manufactured semiconductor packaging parts.

Therefore, there has been continuous demand in the industry for epoxy materials with improved thermal expansion properties that solve the problems of warpage and/or cracking in semiconductor packaging due to the high CTE of epoxy materials and ensure processability and reliability of parts in the semiconductor packaging process. In this regard, the present inventors developed and filed an epoxy resin having an alkoxysilyl group with improved thermal expansion properties (i.e., the lowered CTE) by introducing the alkoxysilyl group into the epoxy resin (Patent Applications 10-2013-0111473, 10-2014-0021884, etc.).

In the semiconductor packaging process, epoxy materials are used as adhesive materials for stacking semiconductor chips or attaching semiconductor chips to a substrate. Here, in order to improve stress relaxation properties of brittle epoxy materials and impart adhesive properties, acrylic resin is blended with epoxy resin in the production of adhesive. As a result, during the curing reaction of epoxy adhesives, a phase separation phenomenon (curing-induced phase separation) occurs between the epoxy and acrylic domains.

The present inventors have found that phase separation properties (characteristic of morphology) of specific structures of a novolac epoxy resins and an acrylic resin affect the thermal expansion properties of a composition comprising an epoxy resin and an acrylic resin. In other words, they found have found that by modifying the novolac epoxy resin to have a specific range of average molecular weight and polydispersity index (PDI), and additionally a specific range of epoxy equivalent weight (EEW) values, and, using the modified novolac epoxy resin, it was found that controlling the phase separation characteristics between epoxy resin and acrylic resin results in further improved thermal expansion properties of compositions comprising both epoxy resin and acrylic resin.

### SUMMARY

The present inventors discovered that an epoxy composition, such as an epoxy adhesive, with improved thermal expansion properties (i.e., the lowered CTE) can be produced by using a novolac epoxy resin modified to have a specific ranges of weight average molecular weight and polydispersity index. Based on this, the present disclosure provides a modified novolac epoxy resin, a method for preparing the same, a composition comprising the same, and uses thereof. The modified epoxy resin of the present disclosure is particularly useful for adhesive films for semiconductors.

According to the first aspect of the present disclosure, a modified epoxy resin is provided which has a weight average molecular weight in the range of 5,000 to 25,000 and a polydispersity index in the range of 5.0 to 20.0, and comprises:
(1) one epoxy-derived unit selected from the group consisting of the following Formula (AF), Formula (BF), and Formula (CF); and
(2) at least one modifier-derived unit selected from the group consisting of the following Formula (1F), Formula (2F), Formula (3F), Formula (4F), Formula (5F), and Formula (6F),
wherein the epoxy-derived unit and the modifier-derived unit are connected via the following Formula (L):

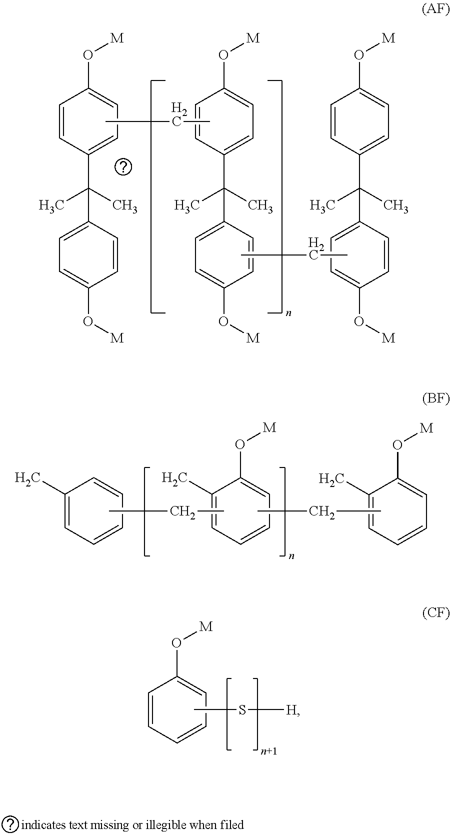

in Formula (CF), S is:

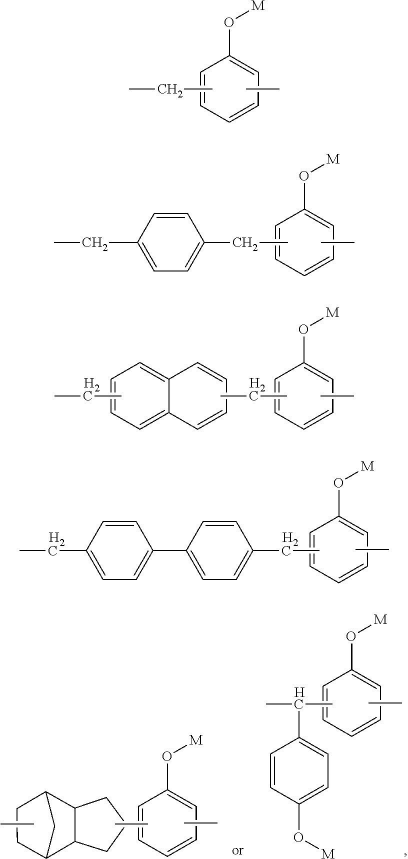

in Formulas (AF) to (CF), n is an integer from 1 to 50,
the epoxy resin has or does not have the structure of the following Formula (7F),
in a case in which the epoxy resin has the structure of the following Formula (7F), at least one of a plurality of M is connected by a single bond to ** in the following Formula (L), at least one is the following Formula (7F), at least one is a glycidyl group of the following Formula (E), and the remainder of M are each independently the single bond to ** in the following Formula (L), the following Formula (7F), or the glycidyl group of the following Formula (E), and
in a case in which the epoxy resin does not have a structure of the following Formula (7F), at least one of a plurality of M is connected by a single bond to ** in the following Formula (L), at least one is a glycidyl group of the following Formula (E), and the remainder of M are each independently connected by the single bond to ** in the following Formula (L) or the glycidyl group of the following Formula (E);

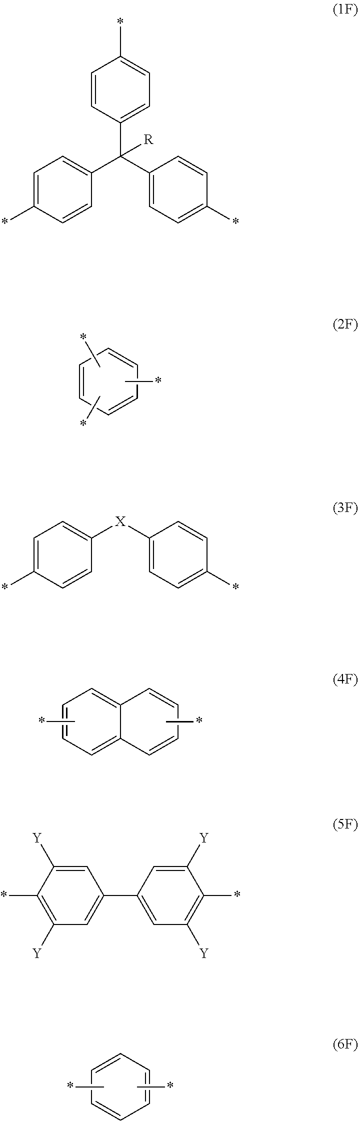

in Formula (1F), R is a methyl group, and in Formula (3F), X is —CH₂—, —C(CH₃)₂—, —C(CF₃)₂—, —S—, or —SO₂—, in Formula (5F), Y is independently selected from H and a methyl group, respectively and in Formulas (1F) to (6F), * is each connected by a single bond to * in the following Formula (L);

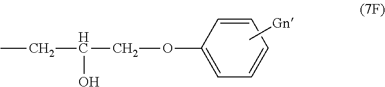

in Formula (7F), G is independently selected from the group consisting of an alkyl group of C1 to C10, an allyl group, and an aryl group of C6 or C10, respectively, and n′ is an integer of 0 to 5;

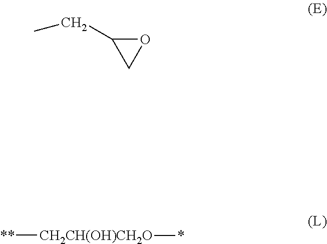

in Formula (L), ** is a connection of a single bond to M in Formula (AF), (BF), or (CF), and * is a connection of a single bond to * in the following Formula (1F), (2F), (3F), (4F), (5F), or (6F).

According to the second aspect, the modified epoxy resin according to the first aspect may have an epoxy equivalent weight (EEW) of 150 g/Eq to 500 g/Eq.

According to the third aspect of the present disclosure, a method of preparing a modified epoxy resin is provided comprising mixing one epoxy resin selected from the group consisting of the following Formulas (AS) to (CS) with at least one modifier selected from the group consisting of the following Formulas (1) to (6) in the presence of 1 to 10 parts by weight of a phosphorus-based catalyst per 100 parts by weight of the modifier, and then heating the resulting mixture:

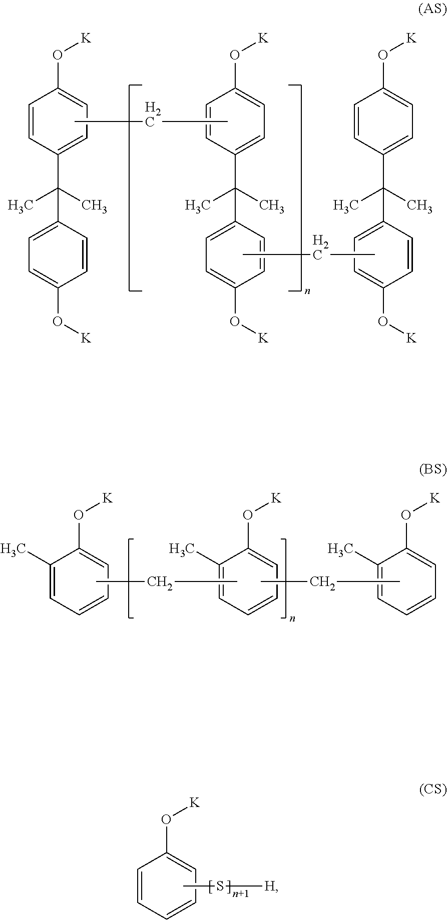

in Formula (CS), S is:

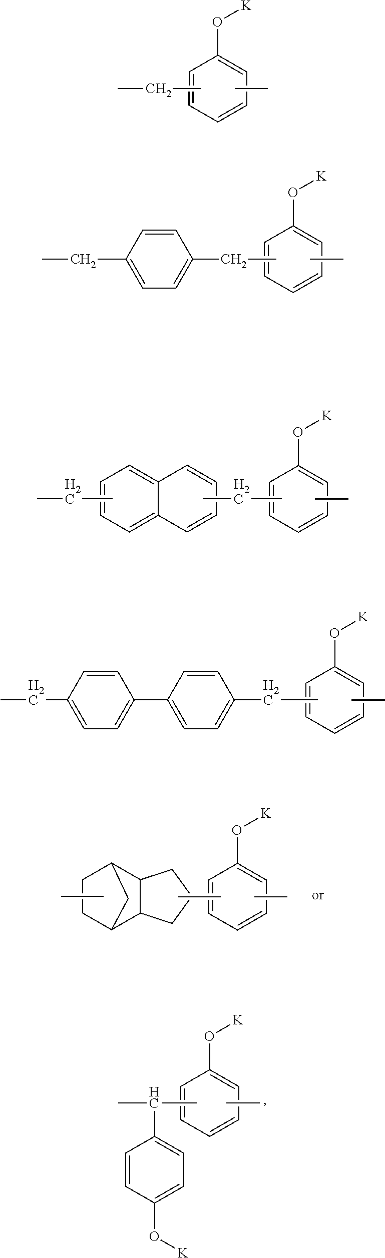

in Formulas (AS) to (CS), n is an integer from 1 to 50, and K is a glycidyl group of the following Formula (E):

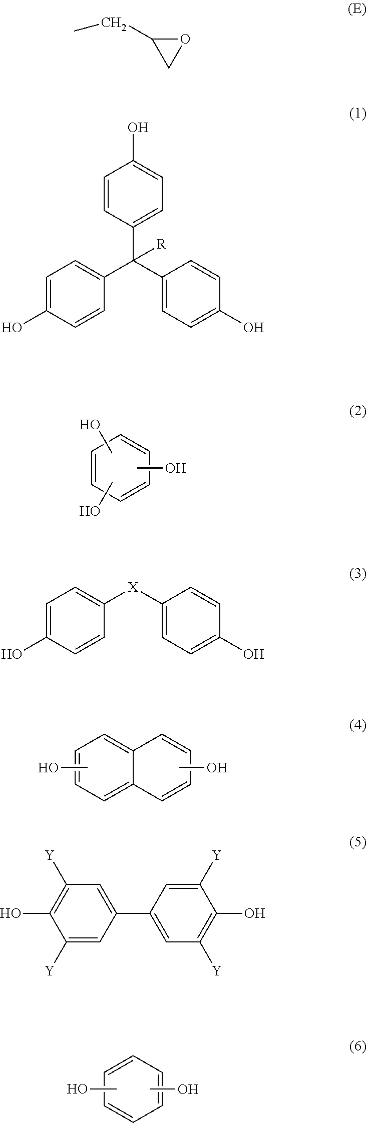

In Formula (1), R is a methyl group, and in Formula (3), X is —CH₂—, —C(CH₃)₂—, —C(CF₃)₂—, —S—, or —SO₂—, and in Formula (5), Y is independently selected from the group consisting of H and a methyl group.

According to a fourth aspect, there is provided a method of preparing a modified epoxy resin according to the third aspect, wherein, when at least one trifunctional modifier selected from the group consisting of Formulas (1) and (2) is used as the modifier, the trifunctional modifier may be used in an amount of 5 to 20 moles of a hydroxy group of the trifunctional modifier per 100 moles of the epoxy group of the epoxy resin as a starting material.

According to a fifth aspect, there is provided a method of preparing a modified epoxy resin according to the third or fourth aspect, wherein, when at least one bifunctional modifier selected from the group consisting of Formulas (3) to (6) is used as the modifier, the bifunctional modifier may be used in an amount of 10 to 30 moles of a hydroxy group of the bifunctional modifier per 100 moles of the epoxy group of the epoxy resin as a starting material.

According to the sixth aspect, there is provided a method of preparing a modified epoxy resin according to any one of the third to fifth aspect, wherein, when at least one trifunctional modifier selected from the group consisting of Formulas (1) and (2) and at least one bifunctional modifier selected from the group consisting of Formulas (3) to (6) are used together as the modifier, the modifier may be used in an amount of 5 to 30 moles of the total hydroxy groups of the difunctional modifier and the trifunctional modifier per 100 moles of the epoxy group of the epoxy resin as a starting material.

According to the seventh aspect, there is provided a method of preparing an epoxy resin according to any one of the third to sixth aspect, wherein a monofunctional modifier of the following Formula (7) may be used together with at least one of the bifunctional modifier and the trifunctional modifier.

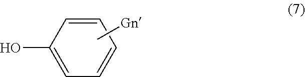

(In above Formula (7), G is independently selected from the group consisting of an alkyl group of C1 to C10, an allyl group, and an aryl group of C6 or C10, respectively, and n′ is an integer of 0 to 5).

According to the eighth aspect, there is provided a method of preparing an epoxy resin according to any one of the third to seventh aspect, wherein the monofunctional modifier may be used in an amount of 30 moles or less of a hydroxy group of the monofunctional modifier per 100 moles of the epoxy group of the epoxy resin as a starting material.

According to the ninth aspect, there is provided a method of preparing an epoxy resin according to any one of the third to eighth aspect, wherein the heating may be performed at a temperature of 80° C. to 140° C.

According to the tenth aspect, there is provided a method of preparing an epoxy resin according to any one of the third to ninth aspect, wherein the heating may be performed for 30 minutes to 10 hours.

According to eleventh aspect of the present disclosure, an epoxy composition is provided comprising an epoxy resin, an acrylic resin, a curing agent, and a curing catalyst, wherein the epoxy resin may include 10% to 90% by weight of the modified epoxy resin of the first or second aspect and 90% to 10% by weight of an unmodified epoxy resin, based on the total weight of the epoxy resin.

According to twelfth aspect, there is provided the epoxy composition according to eleventh aspect, wherein the content of the acrylic resin may be 20 to 1000 parts by weight, based on 100 parts by weight of the epoxy resin.

According to thirteenth aspect, there is provided the epoxy composition according to eleventh or twelfth aspect, wherein the epoxy composition may further comprise an inorganic filler.

According to fourteenth aspect, there is provided the epoxy composition of any one of eleventh to thirteenth aspect, wherein the epoxy composition may be used as an adhesive.

According to fifteenth aspect of the present disclosure, there is provided a semiconductor adhesive film comprising the epoxy composition according to any one of eleventh to fourteenth aspect.

According to sixteenth aspect of the present disclosure, there is provided a cured product of the epoxy composition according to eleventh aspect.

According to seventeenth aspect of the present disclosure, there is provided an article comprising the cured product according to sixteenth aspect.

### BRIEF DESCRIPTION OF DRAWINGS

The FIGURE illustrates a reaction mechanism for preparing a modified epoxy resin by the method of the present disclosure, in which a cresol novolac epoxy resin is modified using a trifunctional modifier.

### DETAILED DESCRIPTION

As described above, in the present disclosure, an epoxy composition comprising a modified epoxy resin having a specific ranges of weight average molecular weight and polydispersity index, and additionally a specific range of EEW according to the present disclosure exhibits further improved thermal expansion properties, that is, the lowered CTE, and is therefore suitable for securing adhesive technology with excellent processability and reliability upon semiconductor packaging.

Hereinafter, a modified epoxy resin of the present disclosure, a preparation method thereof, an epoxy composition comprising the same, and uses thereof will be described in detail, respectively.

1. Modified Epoxy Resin

According to one embodiment of the present disclosure,
a modified epoxy resin is provided which has a weight average molecular weight in the range of 5,000 to 25,000 and a polydispersity index in the range of 5.0 to 20.0, and comprises: (1) one epoxy-derived unit selected from the group consisting of the following Formula (AF), Formula (BF), and Formula (CF); and
(2) at least one modifier-derived unit selected from the group consisting of the following Formula (1F), Formula (2F), Formula (3F), Formula (4F), Formula (5F), and Formula (6F),
wherein the epoxy-derived unit and the modified-derived unit are connected via the following Formula (L):

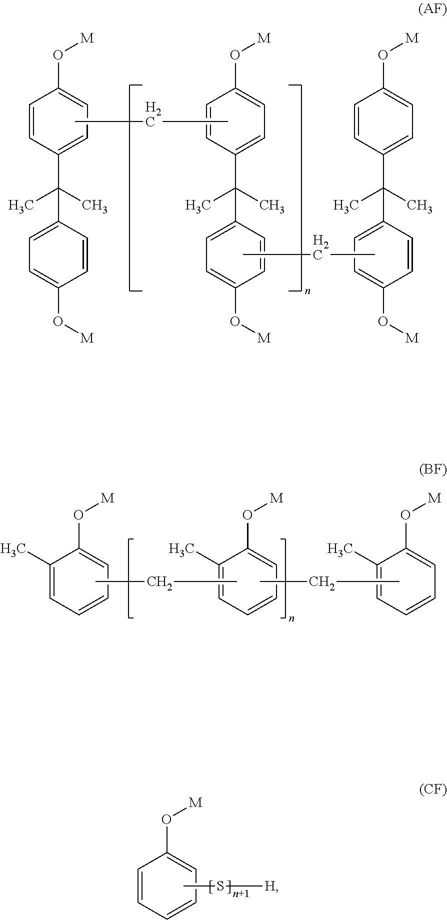

in Formula (CF), S is:

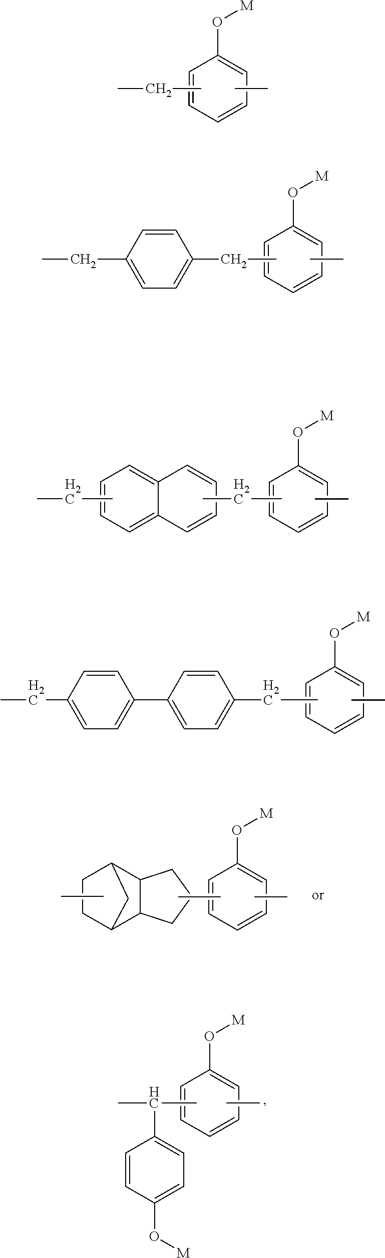

in Formulas (AF) to (CF), n is an integer from 1 to 50, and more preferably an integer from 1 to 30,
the epoxy resin has or does not have a structure of the following Formula (7F),
in a case in which the epoxy resin has the structure of the following Formula (7F), at least one of a plurality of M is connected by a single bond to ** in the following Formula (L), at least one is the following Formula (7F), at least one is a glycidyl group of the following Formula (E), and the remainder of M are respectively independently the single bond to ** in the following Formula (L), the following Formula (7F), or the glycidyl group of the following Formula (E), and
in a case in which the epoxy resin does not have a structure of the following Formula (7F), at least one of a plurality of M is connected by a single bond to ** in the following Formula (L), at least one is a glycidyl group of the following Formula (E), and the remainder of M are respectively independently connected by the single bond to ** in the following Formula (L) or the glycidyl group of the following Formula (E);

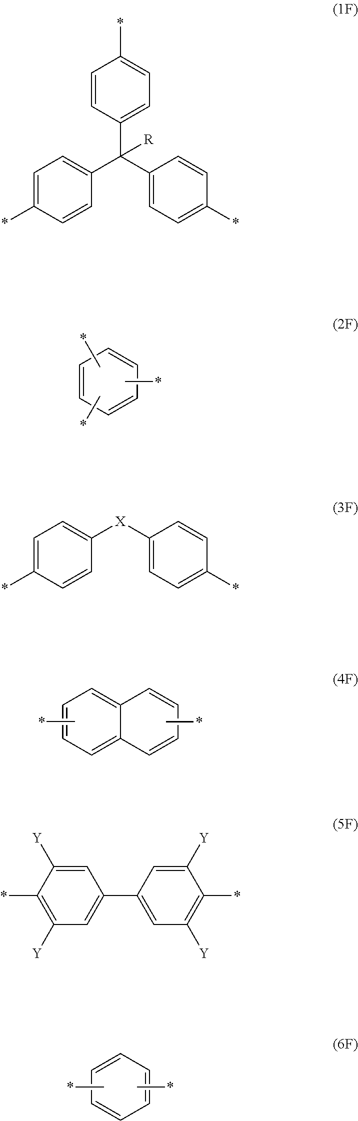

in Formula (1F), R is a methyl group, and in Formula (3F), X is —CH₂—, —C(CH₃)₂—, —C(CF₃)₂—, —S—, or —SO₂—, in Formula (5F), Y is respectively independently selected from H and a methyl group, and in Formulas (1F) to (6F), * is each connected by a single bond to * in the following Formula (L);

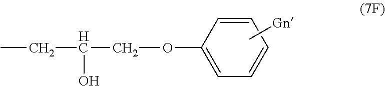

in Formula (7F), G is independently selected from the group consisting of an alkyl group of C1 to C10, an allyl group, and an aryl group of C6 or C10, respectively, and n′ is an integer of 0 to 5;

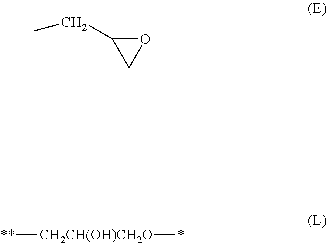

in Formula (L), ** is a connection of a single bond to M in Formula (AF), (BF), or (CF), and * is a connection of a single bond to * in the following Formula (1F), (2F), (3F), (4F), (5F), or (6F).

In addition, the modified epoxy resin is a resin and therefore has at least two epoxy groups overall. Meanwhile, for example, when the epoxy-derived unit (e.g., Formula (AF)) and the modifier-derived unit (e.g., Formula (1F)) are connected by Formula (L), the M part of the epoxy-derived unit connected by Formula (L) in the three * parts of the modifier-derived unit may be the different M part of the same epoxy-derived unit or the M part of a different epoxy-derived unit (i.e., a different Formula (AF)).

The modified epoxy resin according to the present disclosure has a weight average molecular weight of 5,000 to 25,000, and preferably 7,000 to 20,000. If the weight average molecular weight is within the above range, the composition comprising the modified epoxy resin described later may have improved thermal expansion properties and processability. If the weight average molecular weight is less than 5,000, it is not desirable in that the thermal expansion properties of the epoxy composition are insufficient, and if the weight average molecular weight exceeds 25,000, it is not desirable in that the processability of the epoxy composition is reduced. The weight average molecular weight is a molecular weight measured by gel permeation chromatography using tetrahydrofuran.

In addition, the modified epoxy resin according to the present disclosure has a polydispersity index in the range of 5.0 to 20.0, and preferably 7.0 to 20.0. If the polydispersity index is 5.0 or higher, it is desirable in that the epoxy composition has both improved processability and thermal expansion properties. If the polydispersity index is less than 5.0, it is not desirable in that the thermal expansion properties of the epoxy composition are insufficient. If the polydispersity index exceeds 20.0, it is undesirable in terms of physical properties such as processability due to excessive high molecular weight polymerization.

Furthermore, the modified epoxy resin according to the present disclosure may have an epoxy equivalent weight (EEW) of 150 g/Eq to 500 g/Eq, and more preferably 200 g/Eq to 350 g/Eq. The EEW of the modified epoxy resin is determined by a concentration (or number) of a glycidyl group of Formula (E). If the EEW is less than 150 g/Eq, it is difficult to secure a sufficiently modified epoxy resin, and if the EEW exceeds 500 g/Eq, a concentration of an epoxide group required for the epoxy resin is insufficient.

When the modified epoxy resin according to the present disclosure is mixed with an acrylic resin, the composition comprising the modified epoxy resin and the acrylic resin exhibits improved thermal expansion properties due to phase separation properties (morphological properties) upon curing. A composition comprising such a modified epoxy resin is suitable for use, for example, in semiconductor packaging, such as an adhesive film for semiconductor packaging, such as DAF or DDAF.

2. Preparation Method of Epoxy Resin

According to another embodiment of the present disclosure, there is provided a method of preparing a modified epoxy resin according to the present disclosure, wherein the modified epoxy resin is prepared by a modification reaction of an epoxy resin as a starting material. In the method of preparing a modified epoxy resin according to the present disclosure, a modified epoxy resin having a specific range of Mw, PDI and additionally EEW as described above is obtained by reaction of the epoxy resin as a starting material with the hydroxy group of the modifier in the presence of a phosphorus-based catalyst.

A schematic concept of the method of preparing a modified epoxy resin according to the present disclosure is shown in a reaction scheme of the FIGURE. The reaction scheme in the FIGURE illustrates, for example, the modification of a cresol novolac epoxy resin with a trifunctional modifier.

Specifically, the method of preparing a modified epoxy resin comprises: mixing one epoxy resin selected from the group consisting of the following Formulas (AS) to (CS) with at least one modifier selected from the following Formulas (1) to (6), in the presence of 1 to 10 parts by weight of a phosphorus-based catalyst per 100 parts by weight of the modifier, and then heating the resulting mixture (hereinafter also referred to as “modification reaction”).

The modification reaction of the epoxy resin as a starting material is carried out by reaction (i.e., modification reaction) of the epoxy resin as the starting material with the modifier in the presence of a mild phosphorus-based catalyst, wherein the reaction is carried out by mixing the epoxy resin as a starting material and the modifier with each other, and then heating the resulting mixture.

As the starting material, one epoxy resin selected from the group consisting of Formulas (AS) to (CS) may be used.

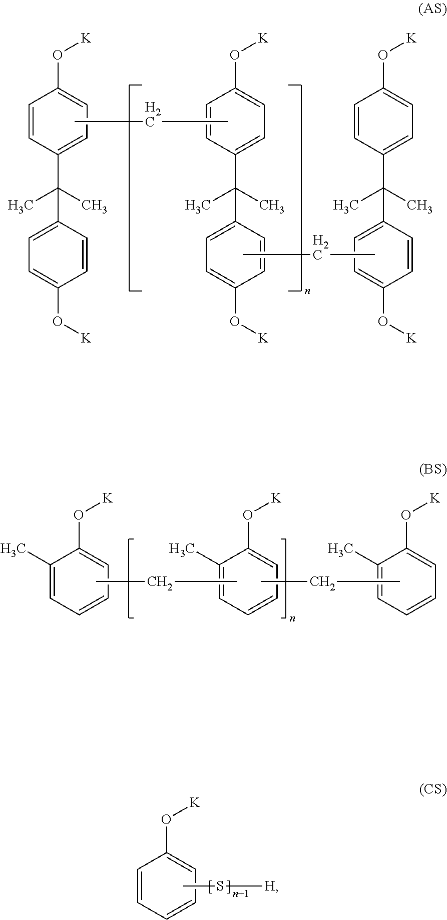

in Formula (CS), S is:

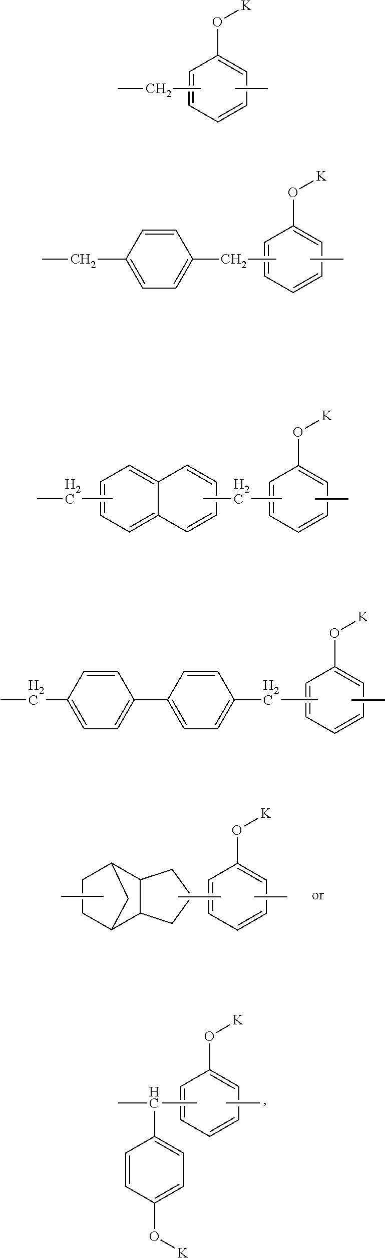

in Formulas (AS) to (CS), n is an integer from 1 to 50, and more preferably an integer from 1 to 30, and K is a glycidyl group of the following Formula (E):

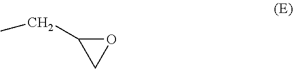

The modifier is an aromatic alcohol compound, and is classified as a trifunctional modifier, a difunctional modifier, or a monofunctional modifier depending on the number of hydroxy groups in the modifier. When an epoxy resin is modified, at least one type selected from the group consisting of a trifunctional modifier and a difunctional modifier may be used as the modifier. Additionally, if necessary, the monofunctional modifier may be additionally used together with at least one modifier selected from the group consisting of a trifunctional modifier and a bifunctional modifier. For example, the modifier may be freely used as a trifunctional modifier, a bifunctional modifier, a mixture of a trifunctional modifier with difunctional modifier, a trifunctional modifier with monofunctional modifier, a bifunctional modifier with monofunctional modifier, or a trifunctional modifier and bifunctional modifier with monofunctional modifier.

As the trifunctional modifier, trifunctional aromatic alcohols represented by the following Formulas (1) and (2) may be used:

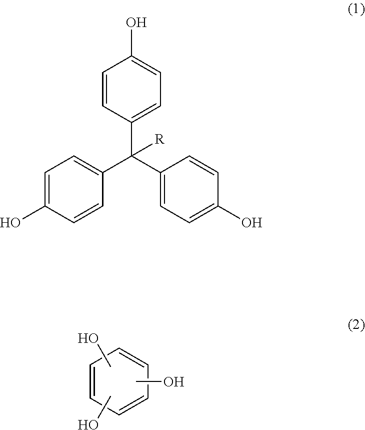

in Formula (1), R is a methyl group.

As the difunctional modifier, difunctional aromatic alcohols represented by the following Formulas (3) to (6) may be used:

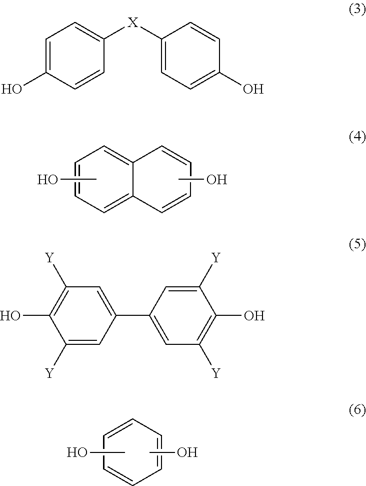

In Formula (3), X is —CH₂—, —C(CH₃)₂—, —C(CF₃)₂—, —S—, or —SO₂—, and in Formula (5), Y is independently selected from the group consisting of H and a methyl group.

As the monofunctional modifier, a monofunctional aromatic alcohol represented by the following Formulas (7) may be used:

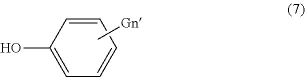

in Formula (7), G is independently selected from the group consisting of an alkyl group of C1 to C10, an allyl group, and an aryl group of C6 or C10, respectively, and n′ is an integer of 0 to 5.

The trifunctional modifier may be used in an amount such that the hydroxyl group of the trifunctional modifier is 5 to 20 moles, and preferably 5 to 15 moles per 100 moles of the epoxy group of the epoxy resin as a starting material.

If the hydroxy group of the trifunctional modifier is used in an amount that is less than 5 mole per 100 moles of the epoxy group of the epoxy resin as a starting material, it is not desirable in that the thermal expansion properties of the modified epoxy resin are not insufficiently improved. If the hydroxy group of the trifunctional modifier is used in an amount that exceeds 20 moles per 100 moles of the epoxy group of the epoxy resin as a starting material, it is not desirable in that the processability of the composition is decreased due to the modified epoxy resin.

The difunctional modifier may be used in an amount such that the hydroxyl group of the bifunctional modifier is 10 to 30 moles, and preferably 10 to 20 moles, per 100 moles of the epoxy group of the epoxy resin as a starting material. If the hydroxy group of the difunctional modifier is used in an amount that is less than 10 mole per 100 moles of the epoxy group of the epoxy resin as a starting material, it is not desirable in that the thermal expansion properties of the modified epoxy resin are not insufficiently improved. If the hydroxy group of the difunctional modifier is used in an amount that exceeds 30 moles per 100 moles of the epoxy group of the epoxy resin as a starting material, it is not desirable in that the processability of the composition is decreased due to the modified epoxy resin.

When a trifunctional modifier and a difunctional modifier are used together as the modifier (a mixed modifier of a trifunctional modifier and a difunctional modifier, hereinafter referred to as “mixed modifier”), the mixed modifier may be used in an amount such that the total hydroxyl group of the mixed modifier is 5 to 30 moles, and preferably 5 to 20 moles per 100 moles of the epoxy group of the epoxy resin as a starting material. If the total hydroxy group of the mixed modifier is used in an amount that is less than 5 moles per 100 moles of the epoxy group of the epoxy resin as a starting material, it is not desirable in that the thermal expansion properties of the modified epoxy resin is not insufficiently improved. If the total hydroxy group of the mixed modifier is used in an amount that exceeds 30 moles per 100 moles of the epoxy group of the epoxy resin as a starting material, it is not desirable in that the processability of the composition is decreased due to the modified epoxy resin.

The monofunctional modifier is additionally used with the trifunctional modifier and/or difunctional modifier if necessary, and is not used alone. The monofunctional modifier may be used in an amount such that, the hydroxy group of the monofunctional modifier is 30 moles or less per 100 moles of the epoxy group of the epoxy resin as the starting material. If the amount of monofunctional modifier exceeds 30 moles per 100 moles of the epoxy group of the epoxy resin as a starting material, it may be difficult to obtain a modified epoxy resin with a polydispersity index of 5 or more. The monofunctional modifier is an optional ingredient that may be added if necessary, and a lower limit thereof may not be limited.

The modification reaction is performed in the presence of a phosphorus-based catalyst as a mild catalyst. As the phosphorus-based catalyst, for example, one or more selected from the group consisting of triphenylphosphine (TPP), diphenylpropylphosphine, and tricyclohexylphosphine may be used.

The phosphorus-based catalyst may be used in an amount of 1 to 10 parts by weight, and preferably 2 to 5 parts by weight, based on 100 parts by weight of the modifier. If the amount of the phosphorus-based catalyst used is less than 1 part by weight, based on 100 parts by weight of the modifier, a rate of the modification reaction due to the action of the catalyst is slow. Even if the amount of the phosphorus-based catalyst used exceeds 10 parts by weight, based on 100 parts by weight of the modifier, no further improvement in a reaction rate is observed, and therefore, it is not desirable to exceed 10 parts by weight.

Because the phosphorus-based catalyst is oxidized and loses its catalytic activity when all of the modifier used in the modification reaction are consumed, (1) it is easy to control the reaction, and (2) there is no necessary to remove the residual phosphorus-based catalyst, so a preparing process is simplified.

In the modification reaction, a base such as NaOH, KOH, K₂HCO₃, or K₂CO₃ are not used as catalysts. The use of such a base makes it difficult to obtain Mw in the range of 5,000 to 25,000 and requires a purification process such as a workup after the modification reaction.

When reactants are mixed for the modification reaction, a solvent may be used optionally if necessary. For example, in the modification reaction, a solvent may not be used if a viscosity of the reactant at a reaction temperature is suitable for the reaction to proceed without a separate solvent. In other words, if the viscosity of the reactant is lowered enough to allow mixing and stirring of the reactant to proceed smoothly without a solvent, a separate solvent is not required, which may be easily determined by those skilled in the art. When a solvent is used, any organic solvent (aprotic solvent) may be used as long as it may dissolve the reactant well, has no adverse effect on the reaction, and may be easily removed after the reaction. Such a solvent is not particularly limited, but may include, for example, acetonitrile, tetrahydrofuran (THF), methyl ethyl ketone (MEK), dimethyl formamide (DMF), dimethyl sulfoxide (DMSO), toluene, xylene, or the like, alone or in combination of two of more thereof. The amount of solvent used is not particularly limited, and may be used in an appropriate amount so long as the reactant is sufficiently soluble and does not have an undesirable effect on the reaction, and may be selected with due consideration by those skilled in the art.

The reaction temperature and reaction time of the heating step will depend on the type of reactant, but the heating step may be performed, for example, at 80° C. to 140° C., and preferably at 100° C. to 120° C. If the temperature is lowered below 80° C., the rate of the modification reaction may be slow, and if the temperature exceeds 140° C., side reactions may occur. The reaction time of the modification reaction may be from 30 minutes to 10 hours, and preferably 1 hour to 8 hours. The optimum reaction time is determined depending on a structure of the epoxy group, degree of ring opening, solvent, amount of catalyst, etc. However, if the reaction time is less than 30 minutes, the reaction may not be completed, and if the reaction time exceeds 10 hours, a desired additional reaction is not proceed, and thus the reaction time of 10 hours or more is not necessary.

The modification reaction results in a modified epoxy resin having a weight average molecular weight of 5,000 to 25,000, and preferably 7,000 to 20,000, and a polydispersity index of 5.0 to 20.0, and preferably 7.0 to 20.0, and preferably an EEW value of 150 to 500 g/Eq, and preferably 200 to 350 g/Eq. On the other hand, in the modification reaction, several epoxy resins having different molecular weights and/or structures may be formed together, depending on variables such as a position of the substituents being reacted, a degree of reaction, etc., and they may be prepared in a mixed state. It is common in a preparation reaction of the polymer resin and is well known to those skilled in the art. Additionally, a modified epoxy resin prepared in a mixed state of various epoxy resins having various molecular weights and/or structures may be used in a mixed state.

3. Epoxy Composition

The modified epoxy resin according to the present disclosure may be used in any field, application, and uses in which epoxy resins have been conventionally used in this technical field. In particular, the modified epoxy resin according to the present disclosure may be used for semiconductor adhesives. Specifically, the modified epoxy resin according to the present disclosure may be used as a material for an adhesive film (e.g., DAF, DDAF, etc.) for stacked and thinned semiconductor packages. More specifically, the modified epoxy resin according to the present disclosure may be used as a component in a composition used for semiconductor packaging.

In another embodiment of the present disclosure, a composition comprising an epoxy resin, an acrylic resin, a curing agent, and a curing catalyst (i.e., an epoxy resin composition, also referred to as “epoxy composition”) is provided wherein the epoxy composition comprises 10% to 90% by weight of the modified epoxy resin according to the present disclosure and 90% to 10% by weight of a conventional epoxy resin, based on the total weight of the epoxy resin. It is desirable that the epoxy composition comprises 10% to 90% by weight of the modified epoxy resin and 90% to 10% by weight of the conventional epoxy resin in terms of improving thermal expansion properties and processability of the epoxy composition due to a curing-induced phase separation (morphology properties) into an epoxy region and an acrylic region when curing of the epoxy composition. That is, the epoxy composition according to the above embodiment of the present disclosure comprises the modified epoxy resin and the conventional epoxy resin of the present disclosure. In order to adjust the processability and physical properties of the epoxy composition according to the present disclosure, the conventional epoxy resin (i.e., unmodified epoxy resin) may be used together.

The “modified epoxy resin of the present disclosure” is a “modified epoxy resin” according to an embodiment of the present disclosure, and the contents described in section 1. Modified epoxy resin are equally applicable.

The conventional epoxy resin refers to any epoxy resin conventionally known in the art, which is not a modified epoxy resin according to the present disclosure, and is also referred to as an “unmodified epoxy resin” for convenience as it is not modified, being compared with the modified epoxy resin of the present disclosure.

The types and/or properties of the conventional epoxy resin are not particularly limited, as these are generally known in the art and will not be described in detail herein.

The conventional epoxy resin may include, but is not limited to, a glycidyl-based epoxy resin selected from the group consisting of a glycidyl ether-based epoxy resin, a glycidylamine-based epoxy resin, and a glycidyl ester-based epoxy resin having bisphenol, biphenyl, naphthalene, benzene, thiodiphenol, fluorene, anthracene, isocyanurate, triphenylmethane, 1,1,2,2-tetraphenylethane, tetraphenylmethane, 4,4′-diaminodiphenylmethane, aminophenol, an alicyclic, aliphatic, or novolac unit; and an alicyclic epoxy resin. For example, one or more selected from these epoxy resins may be used. The conventional epoxy resin includes both liquid and solid epoxy resins.

As the conventional epoxy resin, a liquid epoxy resin or a mixture of a liquid epoxy resin and a solid epoxy resin may be used in terms of film processability. The use of liquid epoxy resin or a mixture of a liquid epoxy resin and a solid epoxy resin as an epoxy resin, in consideration of properties such as processability, dryness, viscosity, etc., in a subsequent process of processing the epoxy composition, is to be adjusted and used appropriately by those skilled in the art, is a matter of technical knowledge of those skilled in the art, and will not be described in detail in this specification.

Acrylic resin is formulated to improve the stress relaxation ability of the epoxy composition and the processability. In the epoxy composition, the acrylic resin is blended in an amount of 20 to 1000 parts by weight, preferably 20 to 500 parts by weight, and more preferably 20 to 200 parts by weight, based on 100 parts by weight of the epoxy resin. If the content of acrylic resin is less than 20 parts by weight, it is difficult to sufficiently secure stress relaxation ability and processability, and if the content of acrylic resin exceeds 1000 parts by weight, it is difficult to secure sufficient thermal expansion properties. As the acrylic resin, any acrylic resin generally known in the art may be used, and the properties of the acrylic resin are not particularly limited.

The epoxy composition according to the embodiment of the present disclosure comprise a curing agent and a curing catalyst for curing the epoxy composition, which are common in the art.

As the curing agent, any curing agent generally known as a curing agent for epoxy resins may be used, and without being particularly limited thereto, for example, polyphenol-based curing agents, acid anhydride-based curing agents, amine-based curing agents, etc., may be used. Details regarding curing agents are generally known in the art and will not be described in detail here.

A content of the curing agent may be adjusted based on the concentration of the epoxide group of the epoxy resin, depending on the desired degree of curing. For example, but without limitation, in terms of degree of curing, efficiency, etc., it is desirable to adjust the content of the curing agent so that a ratio of an equivalent weight of the epoxide group to an equivalent weight of a reactive functional group with the epoxide group of the curing agent is 1:0.5 to 2.0, and preferably 1:0.8 to 1.5. The reactive functional group with the epoxide group of the curing agent is, for example, an amine group in amine-based curing agents and phenolic hydroxy group in polyphenol-based curing agents, and is generally known in the art.

As the curing catalyst, any curing catalyst known to be generally used in the curing of epoxy compositions in the art may be used. For example, but without limitation, curing catalysts such as imidazole-based catalysts, phosphorus-based compounds, tertiary amine-based catalysts, quaternary ammonium-based catalysts, and organic acid salt-based catalysts may be used. Details regarding such curing catalysts are generally discussed in the art and will not be described in detail here.

The curing catalyst may be formulated and used in amounts generally used in the art. For example, but without limitation, the curing catalyst may be used in an amount of 0.1 to 10 parts by weight, for example, 0.2 to 5 parts by weight, based on 100 parts by weight of the epoxy resin. The curing catalyst may be used in the above amount in terms of the effect of promoting the curing reaction and controlling the curing reaction rate. By using the curing catalyst in a formulated amount in the above range, curing is effectively catalyzed, and an improvement in work throughput may be expected.

According to another embodiment of the present disclosure, the epoxy resin composition according to the present disclosure may further comprise an inorganic filler if necessary. The inorganic filler is an ingredient generally used in the art to reinforce the physical properties of epoxy compositions.

For example, but without limitation, as the inorganic filler, any inorganic filler known to be used to reinforce the physical properties of conventional epoxy resins may be used. For example, but without limitation, the inorganic filler may be at least one selected from the group consisting of silica (e.g., including fused silica and crystalline silica), metal oxides such as zirconia, titania, alumina, etc., silicon nitride, aluminum nitride, and silsesquioxane. The inorganic filler may be used alone or in a mixture of two or more thereof. The inorganic filler is generally known in the art and will not be describe in detail here.

The inorganic filler may be formulated in consideration of physical properties and/or processability in the range commonly used in the art, for example, but is not limited thereto, 60% by weight or less, and preferably 50% by weight or less, based on the total weight of the solid content of the epoxy composition. If the inorganic filler exceeds 60% by weight, the process may be difficult, and the inorganic filler is a selectively formulated ingredient and the lower limit is not limited.

As used herein, “total weight of solid content of the epoxy composition” refers to the total weight of the solid content of the epoxy composition that is cured after any liquid component, such as the used solvent, is removed when a solvent may be used and/or a liquid component may accidentally exist in the epoxy composition. For example, based on the total weight of the solid content of the epoxy composition of the present disclosure, the remaining content (e.g., if the inorganic filler is 60% by weight based on the total weight of the solid content of the epoxy composition, the remaining content is 40% by weight) excluding the content of the inorganic filler is the content of all organic components such as epoxy resin, acrylic resin, curing agent, curing catalyst, and other additives described later.

The epoxy composition according to any embodiment of the present disclosure may also be blended with other additives such as flame retardants, plasticizers, antimicrobial agents, leveling agents, defoamers, colorants, stabilizers, coupling agents, viscosity modifiers, diluents, molding agents, etc., that are commonly blended in epoxy compositions in this art, if necessary, in order to adjust the physical properties of the epoxy composition without compromising the physical properties of the epoxy composition. Additionally, the solvent may be used to disperse the epoxy composition, if necessary, so that the blends may be easily dispersed before curing. The types, formulations, contents, etc., of these other additives and/or solvents are generally known to those skilled in the art and will not be described in detail here.

The epoxy composition according to one embodiment of the present disclosure may be used for adhesives, such as for semiconductor adhesives, and is suitable for use in, for example, the manufacture of semiconductor adhesive films (e.g., DAF, DDAF, etc.).

According to another embodiment according to the present disclosure, a cured product of the epoxy composition according to any of the above embodiments is provided. The cured product may be obtained by curing, for example, heat curing the epoxy composition. One skilled in the art may suitably select any curing method and curing conditions generally known in the art to cure the epoxy composition, and the curing methods and/or curing conditions are not particularly limited. In addition, the curing methods and curing conditions of the epoxy composition are generally known in the technical field and will not be described in detail here. The cured product is used in a sense that include a composite.

According to another embodiment of the present disclosure, there is provided an article including any of the epoxy compositions and/or cured products of the present disclosure as described above. The article may be an adhesive for a semiconductor, an adhesive film, DAF, DDAF, etc.; and a semiconductor part including an adhesive for a semiconductor, an adhesive film, DAF, DDAF, etc.

As described above, the epoxy composition comprising the modified epoxy resin according to the present disclosure has improved thermal expansion properties, and by applying the epoxy composition to an adhesive for a semiconductor, specifically an adhesive film such as DAF and DDAF, warpage and cracking problems in semiconductor packaging are prevented. Accordingly, the processability of semiconductor packaging and product reliability are improved.

### EXAMPLES

Hereinafter, the present disclosure will be described in more detail with reference to the following Examples. However, the present disclosure is not limited to the following Examples.

### A. Synthesis Examples

### Synthesis Example 1

At room temperature (20 to 25° C., same hereinafter), 65 g of bisphenol A novolac epoxy resin (EEW 210 g/Eq), 3.95 g of 1,1,1-tris(4-hydroxyphenyl)ethane, and 16.3 g of methyl ethyl ketone (MEK) were added to a two-necked flask and stirred for 30 minutes to prepare a uniform solution. Afterwards, 0.12 g of triphenylphosphine (TPP) was added to the flask, and then heated and stirred at 100° C. for 5 hours to obtain a modified epoxy resin. After completion of the reaction, a modified epoxy resin having EEW=261 g/Eq, weight average molecular weight (Mw)=22,000, and polydispersity index=13.5 was obtained. The weight average molecular weight (Mw) was measured by gel permeation chromatography using tetrahydrofuran. The polydispersity index (PDI, Mw/Mn) is a value obtained by measuring the weight average molecular weight (Mw) and number average molecular weight (Mn) by gel permeation chromatography using tetrahydrofuran. The method of obtaining Mw and PDI values is the same in Synthesis Examples 2 to 7.

### Synthesis Example 2

At room temperature, 65 g of bisphenol A novolac epoxy resin (EEW 210 g/Eq), 2.64 g of 1,1,1-tris(4-hydroxyphenyl)ethane, 2.15 g of 1,3-benzenediol, and 16 g of methyl ethyl ketone (MEK) were added to a two-necked flask and stirred for 30 minutes to prepare a uniform solution. Afterwards, 0.14 g of triphenylphosphine (TPP) was added to the flask, and then heated and stirred at 100° C. for 6 hours to obtain a modified epoxy resin. After completion of the reaction, a modified epoxy resin having EEW=286 g/Eq, weight average molecular weight (Mw)=24,000, and polydispersity index=12.0 was synthesized.

### Synthesis Example 3

At room temperature, 65 g of bisphenol A novolac epoxy resin (EEW 210 g/Eq), 1.32 g of 1,1,1-tris(4-hydroxyphenyl)ethane, 2.95 g of bisphenol A, 2.43 g of phenol, and 16 g of methyl ethyl ketone (MEK) were added to a two-necked flask and stirred for 30 minutes to prepare a uniform solution. Afterwards, 0.13 g of triphenylphosphine (TPP) was added to the flask, and then heated and stirred at 110° C. for 3 hours to obtain a modified epoxy resin. After completion of the reaction, a modified epoxy resin having EEW=295 g/Eq, weight average molecular weight (Mw)=15,000, and polydispersity index=7.0 was synthesized.

### Synthesis Example 4

At room temperature, 65 g of bisphenol A novolac epoxy resin (EEW 210 g/Eq), 1.32 g of 1,1,1-tris(4-hydroxyphenyl)ethane, 4.13 g of 1,6-dihydroxynaphthalene, and 16 g of methyl ethyl ketone (MEK) were added to a two-necked flask and stirred for 30 minutes to prepare a uniform solution. Afterwards, 0.11 g of triphenylphosphine (TPP) was added to the flask, and then heated and stirred at 120° C. for 4 hours to obtain a modified epoxy resin. After completion of the reaction, a modified epoxy resin having EEW=289 g/Eq, weight average molecular weight (Mw)=19,000, and polydispersity index=10.8 was synthesized.

### Synthesis Example 5

At room temperature, 65 g of phenol novolac epoxy resin (EEW 180 g/Eq), 1.27 g of 1,3,5-trihydroxybenzene, 3.44 g of bisphenol A, and 16 g of methyl ethyl ketone (MEK) were added to a two-necked flask and stirred for 30 minutes to prepare a uniform solution. Afterwards, 0.14 g of triphenylphosphine (TPP) was added to the flask, and then heated and stirred at 110° C. for 4 hours to obtain a modified epoxy resin. After completion of the reaction, a modified epoxy resin having EEW=235 g/Eq, weight average molecular weight (Mw)=18,000, and polydispersity index=9.8 was synthesized.

### Synthesis Example 6

At room temperature, 65 g of ortho-cresol novolac epoxy resin (EEW 200 g/Eq), 1.14 g of 1,3,5-trihydroxybenzene, 3.83 g of phenol, and 16 g of methyl ethyl ketone (MEK) were added to a two-necked flask and stirred for 30 minutes to prepare a uniform solution. Afterwards, 0.10 g of triphenylphosphine (TPP) was added to the flask, and then heated and stirred at 110° C. for 3.5 hours to obtain a modified epoxy resin. After completion of the reaction, a modified epoxy resin having EEW=271 g/Eq, weight average molecular weight (Mw)=13,000, and polydispersity index=7.1 was synthesized.

### Synthesis Example 7

At room temperature, 65 g of ortho-cresol novolac epoxy resin (EEW 200 g/Eq), 3.79 g of 4,4′-biphenol, and 16 g of methyl ethyl ketone (MEK) were added to a two-necked flask and stirred for 30 minutes to prepare a uniform solution. Afterwards, 0.11 g of triphenylphosphine (TPP) was added to the flask, and then heated and stirred at 120° C. for 5 hours to obtain a modified epoxy resin. After completion of the reaction, a modified epoxy resin having EEW=247 g/Eq, weight average molecular weight (Mw)=13,500, and polydispersity index=8.0 was synthesized.

2. Composite Preparation and Thermal Expansion Property Evaluation

(1) Preparation of Epoxy Filler Composite

With the composition shown in Table 1 below, a phenol curing agent and silica were dissolved in methyl ethyl ketone so that the solid content is 80% by weight. This mixture was mixed for 10 minutes, then acrylic resin and epoxy resin were added thereto and mixed for a further 30 minutes. Next, the curing catalyst was added thereto and mixed for a further 10 minutes to obtain a uniform solution. The mixture was cast onto a release paper and then dried in an oven at 80° C. for 30 minutes. The dried sample was cured at 120° C. for 1 hour and at 180° C. for 2 hours. The physical properties were evaluated by manufacturing a specimen for measuring physical properties in a size of 4 mm×40 mm×0.1 mm (mm³).

(2) Evaluation of Thermal Expansion Properties

The dimensional changes depending on the temperature of the cured products obtained in Inventive Examples and Comparative Examples in Table 1 below were evaluated using a thermo-mechanical analyzer, and the results are shown in Table 1 below.

TABLE 1
Composition of epoxy composition and heat resistance properties of cured product

| | Compound (Number | | Inventive | Inventive | Inventive | Inventive | Inventive | Inventive | Inventive | Comp. | Comp. |
|---|---|---|---|---|---|---|---|---|---|---|---|
| | of Synthesis Ex.) | | Ex. 1 | Ex. 2 | Ex. 3 | Ex. 4 | Ex. 5 | Ex. 6 | Ex. 7 | Ex. 1 | Ex. 2 |
| Composition | Epoxy | Synthesis | 1.8 | — | — | — | — | — | — | — | |
| of | Resin | Ex. 1 | | | | | | | | | |
| Formulation | | Synthesis | — | 1.5 | — | — | — | — | — | — | |
| | | Ex. 2 | | | | | | | | | |
| | | Synthesis | | | 1.5 | — | — | — | — | | |
| | | Ex. 3 | | | | | | | | | |
| | | Synthesis | — | — | — | 1.5 | — | — | — | — | |
| | | Ex. 4 | | | | | | | | | |
| | | Synthesis | — | — | — | — | 1.8 | — | — | — | |
| | | Ex. 5 | | | | | | | | | |
| | | Synthesis | — | — | — | — | — | 1.8 | — | — | |
| | | Ex. 6 | | | | | | | | | |
| | | Synthesis | — | — | — | — | — | — | 2.0 | — | |
| | | Ex. 7 | | | | | | | | | |
| | | DGEBA⁽¹⁾ | 1.2 | 1.5 | 1.5 | 1.5 | 1.2 | 1.2 | 1.1 | 1.2 | 1.2 |
| | | BPA Novolac | — | — | — | — | — | — | — | 1.8 | — |
| | | Epoxy Resin⁽²⁾ | | | | | | | | | |
| | | Phenol Novolac | — | — | — | — | — | — | — | — | 1.8 |
| | | Epoxy Resin⁽³⁾ | | | | | | | | | |
| | Acrylic Polymer⁽⁴⁾ | | 2.29 | 2.29 | 2.28 | 2.29 | 2.34 | 2.28 | 2.30 | 2.39 | 2.42 |
| | Phenol Novolac⁽⁵⁾ | | 1.58 | 1.57 | 1.55 | 1.56 | 1.67 | 1.60 | 1.60 | 1.78 | 1.83 |
| | 2-Phenyl-imidazole | | 0.01 | 0.01 | 0.01 | 0.01 | 0.01 | 0.01 | 0.01 | 0.01 | 0.01 |
| | Silica | | 4.59 | 4.58 | 4.56 | 4.57 | 4.68 | 4.56 | 4.61 | 4.79 | 4.84 |
| Heat | CTE | α₁ (T < T_{g}) | 40.5 | 42.0 | 65.6 | 58.5 | 63.4 | 51.8 | 67.6 | 108 | 103 |
| Resistance | (ppm/° C.) | α₂ (T < T_{g}) | 122 | 112 | 103 | 110 | 121 | 118 | 125 | 180 | 185 |

| | | | | | | | | | |
|---|---|---|---|---|---|---|---|---|---|
| Tg (° C.) | 173° C. | 175° C. | 181° C. | 180° C. | 174° C. | 176° C. | 171° C. | 165° C. | 166° C. |

⁽¹⁾DGEBA (Diglycidyl ether of bisphenol A) EEW = 180 g/Eq
⁽²⁾EEW = 210 g/ Eq;
⁽³⁾EEW = 200 g/Eqα
⁽⁴⁾Paracron ®, Negami Chem. Ind.
⁽⁵⁾Phenol Novolac currect agnet, HEW = 119 g/mol

As shown in Table 1, the epoxy composition according to the present disclosure comprising the modified epoxy resin of the present disclosure of Inventive Examples 1 to 7 exhibited significantly lower CTE (α₁ and α₂) compared to the epoxy compositions of Comparative Examples 1 and 2 that did not comprise the modified epoxy resin disclosed in the present disclosure. In addition, the compositions of Inventive Examples 1 to 7 showed a higher glass transition temperature (Tg) than the compositions of Comparative Examples 1 and 2. As such, the epoxy composition comprising the modified epoxy resin of the present disclosure and acrylic resin had improved thermal expansion properties.

The modified epoxy resin according to the present disclosure has a weight average molecular weight (Mw) of 5,000 to 25,000 and a polydispersity index (PDI) of 5.0 to 20.0, and by using the modified novolac epoxy resin according to the present disclosure having such a controlled weight average molecular weight distribution and polydispersity index, the composition comprising the modified epoxy resin and the acrylic resin may have improved physical properties, for example, the thermal expansion properties (i.e., lower coefficient of thermal expansion (CTE)).

Specifically, when the epoxy composition comprising the epoxy resin and the acrylic resin is cured, a curing-induced phase separation (morphological properties) into an epoxy region and an acrylic region occurs. The epoxy compositions comprising a modified epoxy resins and an acrylic resin have a lower coefficient of thermal expansion (CTE), that is, improved thermal expansion properties, due to the morphological properties during curing of the epoxy composition when the modified epoxy resins according to the present disclosure in the epoxy composition are used. In other words, according to the present disclosure, by using the modified epoxy resin having an Mw of 5,000 to 25,000 and a PDI of 5.0 to 20.0, and preferably the modified epoxy resin having an Mw of 5,000 to 25,000, a PDI of 5.0 to 20.0, and an EEW of 150 to 500 g/Eq in the epoxy composition comprising the epoxy resin and the acrylic resin, the epoxy composition comprising the epoxy resin and the acrylic resin exhibits improved thermal expansion properties due to the morphological properties.

Therefore, the composition comprising a modified epoxy resin according to the present disclosure is suitable for use in epoxy applications where low CTE property is required, for example, an adhesive film for a semiconductor, such as a die attach film (DAF), a dicing die attach film (DDAF), etc.

In addition, in the method of preparing the modified epoxy resin according to the present disclosure, the use of specific modifiers and/or their mixed ratios are adjusted to effectively prepare a modified epoxy resin having a specific range of weight average molecular weight and polydispersity index, and additionally a specific range of EEW, which is formulated into the epoxy composition so that the epoxy composition exhibits excellent thermal expansion properties.

What is claimed is:

1. A modified epoxy resin having a weight average molecular weight in the range of 5,000 to 25,000 and a polydispersity index in the range of 5.0 to 20.0, the modified epoxy resin comprising:
(1) one epoxy-derived unit selected from the group consisting of the following Formula (AF), Formula (BF), and Formula (CF); and
(2) at least one modifier-derived unit selected from the group consisting of the following Formula (1F), Formula (2F), Formula (3F), Formula (4F), Formula (5F), and Formula (6F),
wherein the epoxy-derived unit and the modifier-derived unit are connected via the following Formula (L): 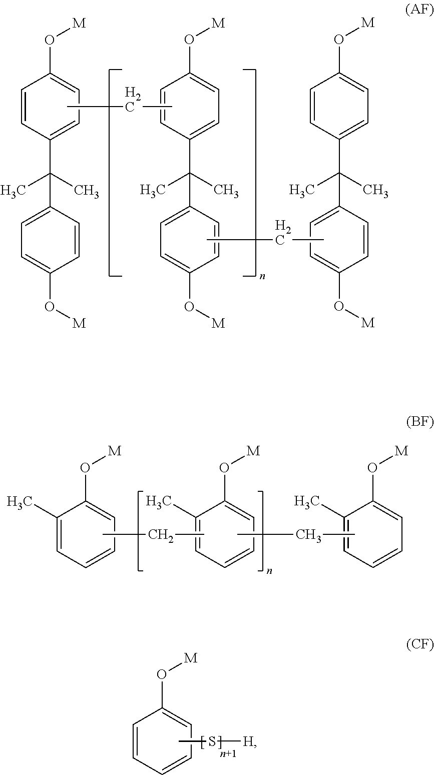
in Formula (CF), S is: 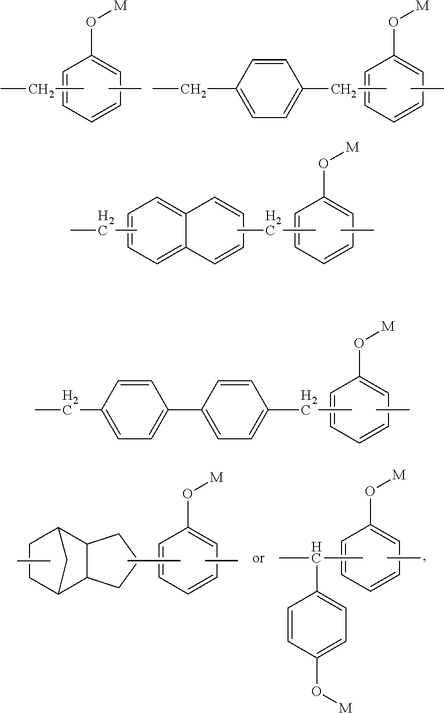
in Formulas (AF) to (CF), n is an integer from 1 to 50,
the epoxy resin has or does not have a structure of the following Formula (7F),
in a case in which the epoxy resin has a structure of the following Formula (7F), at least one of a plurality of M is connected by a single bond to ** in the following Formula (L), at least one is the following Formula (7F), at least one is a glycidyl group of the following Formula (E), and the remainder of M are each independently the single bond to ** in the following Formula (L), the following Formula (7F), or the glycidyl group of the following Formula (E), and
in a case in which the epoxy resin does not have a structure of the following Formula (7F), at least one of a plurality of M is connected by a single bond to ** in the following Formula (L), at least one is a glycidyl group of the following Formula (E), and the remainder of M are respectively independently connected by the single bond to ** in the following Formula (L) or the glycidyl group of the following Formula (E); 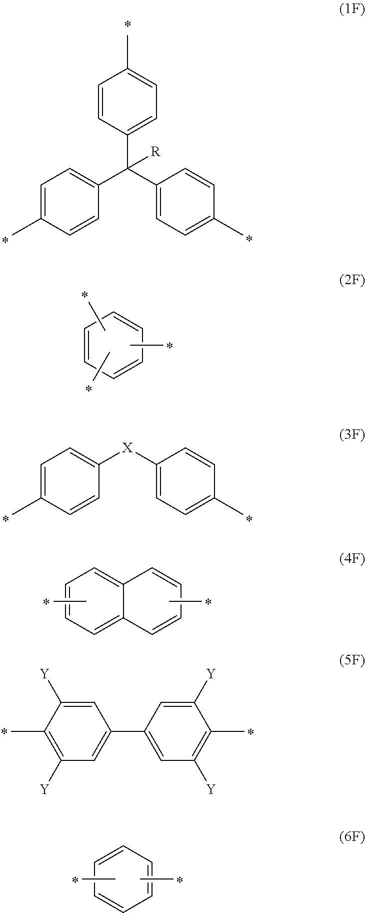
in Formula (1F), R is a methyl group, and in Formula (3F), X is —CH₂—, —C(CH₃)₂—, —C(CF₃)₂—, —S—, or —SO₂—, in Formula (5F), Y is independently selected from H and a methyl group, respectively and in Formulas (1F) to (6F), * is each connected by a single bond to * in the following Formula (L); 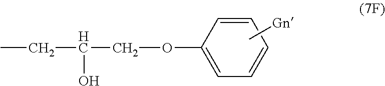
in Formula (7F), G is independently selected from the group consisting of an alkyl group of C1 to C10, an allyl group, and an aryl group of C6 or C10, respectively, and n′ is an integer of 0 to 5; 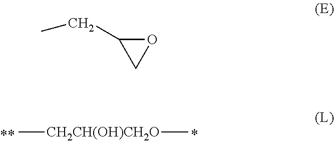
in Formula (L), ** is a connection of a single bond to M in Formula (AF), (BF), or (CF), and * is a connection of a single bond to * in the Following Formula (1F), (2F), (3F), (4F), (5F), or (6F).

2. The modified epoxy resin of claim 1, wherein the modified epoxy resin has an epoxy equivalent weight (EEW) of 150 g/Eq to 500 g/Eq.

3. A method of preparing a modified epoxy resin comprising: mixing one epoxy resin selected from the group consisting of the following Formulas (AS) to (CS) with at least one modifier selected from the group consisting of the following Formulas (1) to (6) in the presence of 1 to 10 parts by weight of a phosphorus-based catalyst per 100 parts by weight of the modifier, and then heating the resulting mixture: 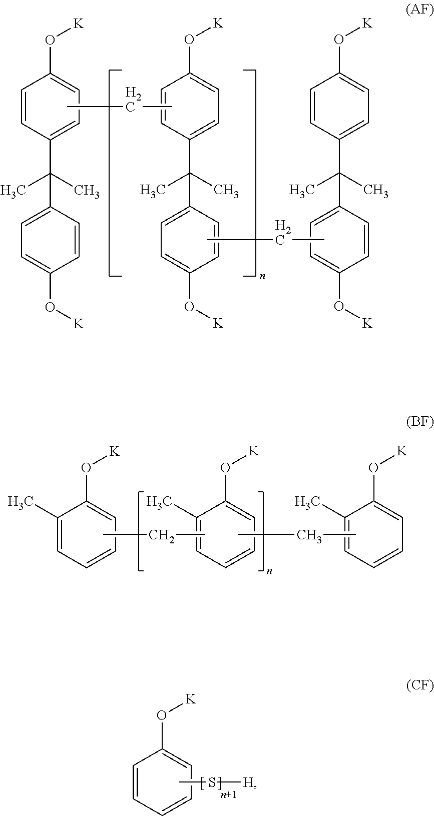
in Formula (CS), S is: 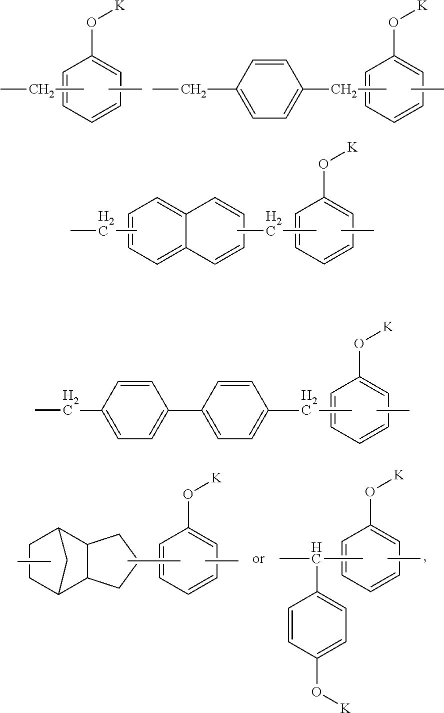
In Formulas (AS) to (CS), n is an integer from 1 to 50, and K is a glycidyl group of the following Formula (E): 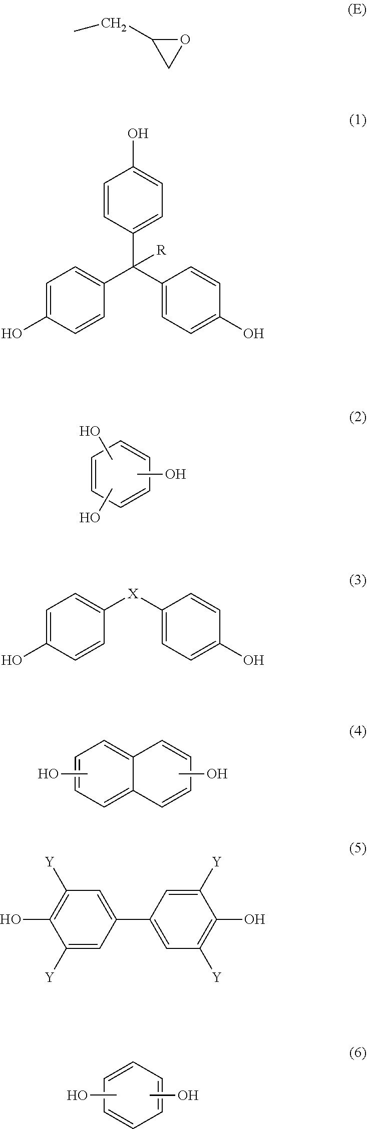
in Formula (1), R is a methyl group, and in Formula (3), X is —CH₂—, —C(CH₃)₂—, —C(CF₃)₂—, —S—, or —SO₂—, and in Formula (5), Y is independently selected from the group consisting of H and a methyl group.

4. The method of claim 3, wherein, when at least one trifunctional modifier selected from the group consisting of Formulas (1) and (2) is used as the modifier, the trifunctional modifier is used in an amount of 5 to 20 moles of a hydroxy group of the trifunctional modifier per 100 moles of the epoxy group of the epoxy resin as a starting material.

5. The method of claim 3, wherein, when at least one bifunctional modifier selected from the group consisting of Formulas (3) to (6) is used as the modifier, the bifunctional modifier is used in an amount of 10 to 30 moles of a hydroxy group of the bifunctional modifier per 100 moles of the epoxy group of the epoxy resin as a starting material.

6. The method of claim 3, wherein, when at least one trifunctional modifier selected from the group consisting of Formulas (1) and (2) and at least one bifunctional modifier selected from the group consisting of Formulas (3) to (6) are used together as the modifier, the modifier is used in an amount of 5 to 30 moles of the total hydroxy groups of the difunctional modifier and the trifunctional modifier per 100 moles of the epoxy group of the epoxy resin as a starting material.

7. The method of claim 3, wherein a monofunctional modifier of the following Formula (7) is used together with at least one modifier selected from the group consisting of the Formulas (1) to (6): 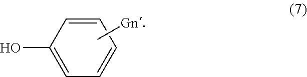
in Formula (7), G is independently selected from the group consisting of an alkyl group of C1 to C10, an allyl group, and an aryl group of C6 or C10, respectively, and n′ is an integer of 0 to 5.

8. The method of claim 7, wherein the monofunctional modifier is used in an amount of 30 moles or less of a hydroxy group of the monofunctional modifier per 100 moles of the epoxy group of the epoxy resin as a starting material.

9. The method of claim 3, wherein the heating is performed at a temperature of 80° C. to 140° C.

10. The method of claim 3, wherein the heating is performed for 30 minutes to 10 hours.

11. An epoxy composition comprising: an epoxy resin, an acrylic resin, a curing agent, and a curing catalyst, wherein the epoxy resin includes 10% to 90% by weight of a modified epoxy resin and 90% to 10% by weight of an unmodified epoxy resin, based on the total weight of the epoxy resin, wherein the modified epoxy resin has a weight average molecular weight in the range of 5,000 to 25,000 and a polydispersity index in the range of 5.0 to 20.0, and preferably an epoxy equivalent weight (EEW) of 150 g/Eq to 500 g/Eq, and comprises:
(1) one epoxy-derived unit selected from the group consisting of the following Formula (AF), Formula (BF), and Formula (CF); and
(2) at least one modifier-derived unit selected from the group consisting of the following Formula (1F), Formula (2F), Formula (3F), Formula (4F), Formula (5F), and Formula (6F),
wherein the epoxy-derived unit and the modifier-derived unit are connected via the following Formula (L): 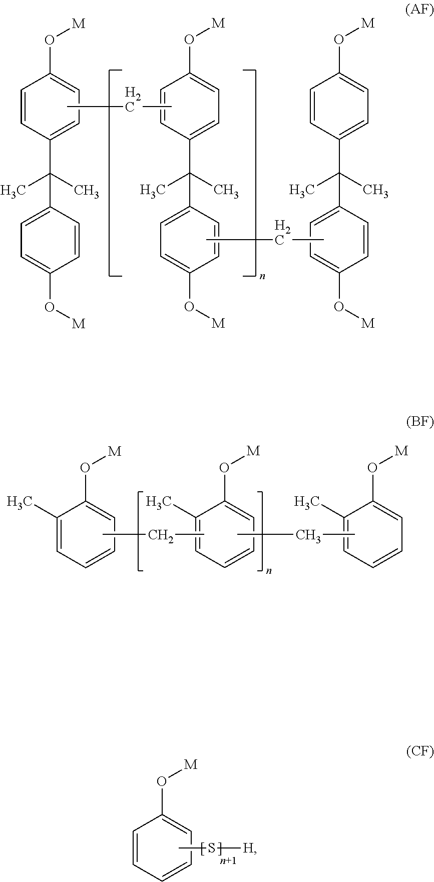
in Formula (CF), S is: 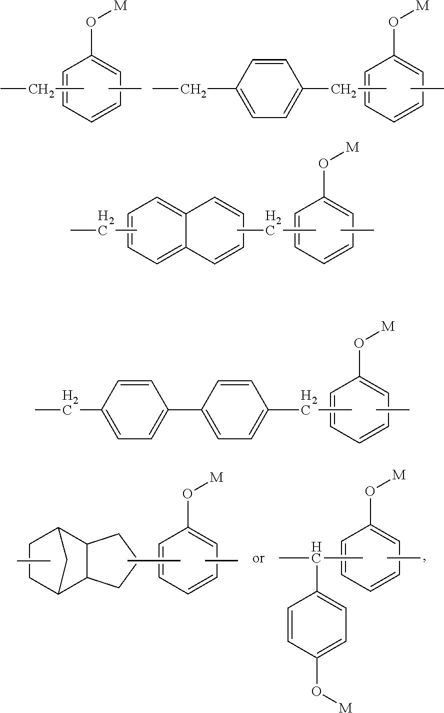
in Formulas (AF) to (CF), n is an integer from 1 to 50,
the epoxy resin has or does not have a structure of the following Formula (7F),
in a case in which the epoxy resin has a structure of the following Formula (7F), at least one of a plurality of M is connected by a single bond to ** in the following Formula (L), at least one is the following Formula (7F), at least one is a glycidyl group of the following Formula (E), and the remainder of M are each independently the single bond to ** in the following Formula (L), the following Formula (7F), or the glycidyl group of the following Formula (E), and
in a case in which the epoxy resin does not have a structure of the following Formula (7F), at least one of a plurality of M is connected by a single bond to ** in the following Formula (L), at least one is a glycidyl group of the following Formula (E), and the remainder of M are respectively independently connected by the single bond to ** in the following Formula (L) or the glycidyl group of the following Formula (E); 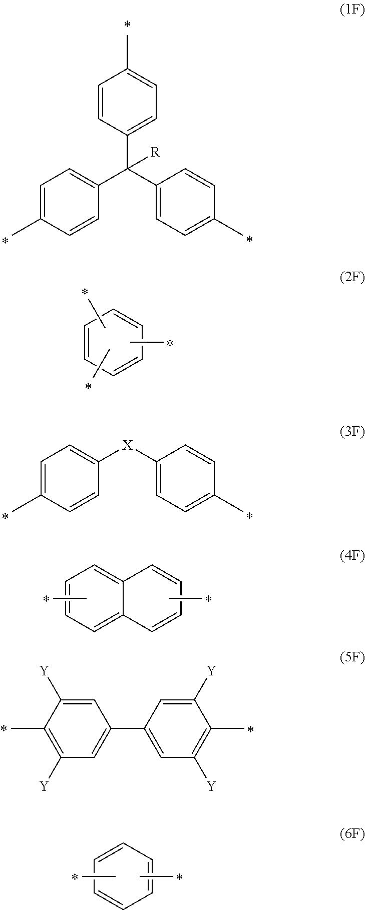
in Formula (1F), R is a methyl group, and in Formula (3F), X is —CH₂—, —C(CH₃)₂—, —C(CF₃)₂—, —S—, or —SO₂—, in Formula (5F), Y is independently selected from H and a methyl group, respectively and in Formulas (1F) to (6F), * is each connected by a single bond to * in the following Formula (L); 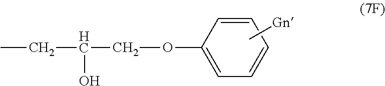
in Formula (7F), G is independently selected from the group consisting of an alkyl group of C1 to C10, an allyl group, and an aryl group of C6 or C10, respectively, and n′ is an integer of 0 to 5; 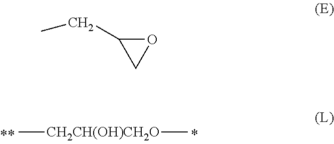
in Formula (L), ** is a connection of a single bond to M in Formula (AF), (BF), or (CF), and * is a connection of a single bond to * in the Following Formula (1F), (2F), (3F), (4F), (5F), or (6F).

12. The epoxy composition of claim 11, wherein a content of the acrylic resin is 20 to 1000 parts by weight, based on 100 parts by weight of the epoxy resin.

13. The epoxy composition of claim 11, wherein the epoxy composition further comprises an inorganic filler.

14. The epoxy composition of claim 11, wherein the epoxy composition is used as an adhesive.

15. A semiconductor adhesive film comprising the epoxy composition of claim 11.

16. A cured product of the epoxy composition of claim 11.

17. An article comprising the cured product of claim 16.
